(19) United States
(12) Patent Application Publication
(10) Pub. No.: US 2009/0102884 A1
(43) Pub. Date: Apr. 23, 2009

(54) FLUID EJECTING APPARATUS AND METHOD OF CONTROLLING SAME

(75) Inventor: Takayuki KAWAKAMI, Matsumoto-Shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/098,288

(22) Filed: Apr. 4, 2008

(30) Foreign Application Priority Data
Apr. 6, 2007 (JP) 2007-100473

(51) Int. Cl. B41J 2/165

(52) U.S. Cl. 347/32; 347/30

(57) ABSTRACT

A fluid ejecting apparatus includes a fluid ejecting head that ejects fluid from a nozzle opening of a nozzle. The fluid ejecting apparatus also has a cap that is operable to move away from or contact the fluid ejecting head. A cap suction means sucks a cap internal space formed between the fluid ejecting head and an inner wall of the cap in a state where the cap is in contact with the fluid ejecting head. A control means measures a pressure in the cap internal space sucked by the cap suction means and determines whether there is a negative pressure equal to or higher than a predetermined value. The control means instructs the cap sliding means to perform a sliding action when the control means determines that the negative pressure that is equal to or higher than the predetermined value is not generated in the cap internal space.

The entire disclosure of Japanese Patent Application No. 2007-100473, filed Apr. 6, 2007, is expressly incorporated by reference herein.

### BACKGROUND OF THE INVENTION

1. Field of the Invention

The invention relates to a fluid ejecting apparatus that ejects fluid from a nozzle opening and, more particularly, to a technology for covering a nozzle opening with a cap and sucks the inside of the cap when a fluid ejecting operation from the nozzle opening is not performed.

2. Description of the Related Art

A typical fluid ejecting apparatus of this type may be, for example, an image recording apparatus, such as an ink jet printer, that performs recording by discharging and landing ink droplets onto a recording medium, such as recording paper. In addition, in recent years, the fluid ejecting apparatus is applied not only to the image recording apparatus but also to various manufacturing equipments. For example, in a manufacturing equipment for a display, such as a liquid crystal display, a plasma display, an organic EL (Electro Luminescence) display, or an FED (field emission display), the fluid ejecting apparatus is used to discharge various liquid materials, such as color materials or electrodes, onto a pixel forming region, an electrode forming region, or the like.

For example, the ink jet printer records an image on a recording material by ejecting ink from the nozzle openings of the ink jet head. In addition, at a non-printing time in which an image recording operation is not performed on a recording material, in order to prevent nozzle clogging because of dried ink, a cap is attached for the nozzle openings. Specifically, the cap has a cap opening that is open toward the ink jet head. At the non-printing time, a cap contact portion, which is provided at the peripheral portion of the cap opening, contacts the ink jet head. Furthermore, the cap is connected to a suction restoration device. That is, if the nozzles are clogged or foreign matter is included into the nozzles, the suction restoration device sucks the nozzles through the cap in a state where the cap is in contact with the ink jet head to thereby remove the clogging or the matter (clogging, or the like) (JP-A-7-108684).

In this manner, in the technology described in the patent document 1, in a state where the cap is in contact with the ink jet head (fluid ejecting head), a cap suction means, such as the suction restoration device, sucks the nozzles to thereby remove clogging, or the like. Specifically, in the technology described in the patent document 1, in a state where the cap is in contact with the fluid ejecting head, a negative pressure is generated in a cap internal space, which is formed between the fluid ejecting head and the inner wall of the cap, by sucking the cap internal space to thereby remove nozzle clogging, or the like. Incidentally, the cap contacts the fluid ejecting head via the cap contact portion formed at the periphery of the cap opening. For this reason, in order to generate a negative pressure in the cap internal space, which is sufficient to remove nozzle clogging, or the like, it is necessary for the cap contact portion to be in close contact with the ink jet head.

However, as is described in the Patent Document 1, when the cap internal space is sucked, the configuration that the cap is just brought into contact with the ink jet head (fluid ejecting head) may cause poor adherence that the cap contact portion is insufficiently adhered to the fluid ejecting head (for example, such poor adherence that the cap contact portion partially does not closely contact the fluid ejecting head). Then, because of such poor adherence, there have been cases in which a sufficient negative pressure cannot be generated in the cap internal space. As a result, this may cause a problem that nozzle clogging, or the like, cannot sufficiently be removed, or the like.

### SUMMARY

The invention addresses the above problem, and it is an object of the invention to provide a technology for making it possible to generate a sufficient negative pressure in the cap internal space by enhancing the adherence of the cap contact portion to the fluid ejecting head.

In order to achieve the above object, a fluid ejecting apparatus according to the invention has such a feature that the fluid ejecting apparatus includes a fluid ejecting head that ejects fluid from a nozzle opening of a nozzle, a cap that has a cap opening open toward the fluid ejecting head and an annular cap contact portion provided at a periphery of the cap opening, that is provided so as to be operable to move away from the fluid ejecting head or contact the fluid ejecting head through the cap contact portion and of which the cap opening covers the nozzle opening in such a manner that the cap contact portion contacts the fluid ejecting head, a cap separate and contact means that moves the cap to thereby move the cap away from the fluid ejecting head or bring the cap into contact with the fluid ejecting head, a cap suction means that sucks a cap internal space formed between the fluid ejecting head and an inner wall of the cap in a state where the cap is in contact with the fluid ejecting head, a control means that measures a pressure in the cap internal space sucked by the cap suction means and determines whether a negative pressure that is equal to or higher than a predetermined value is generated in the cap internal space, and a cap sliding means that performs a sliding action in which the cap contact portion is made to slide over the fluid ejecting head in a state where the cap is in contact with the fluid ejecting head, wherein the control means instructs the cap sliding means to perform the sliding action when the control means determines that the negative pressure that is equal to or higher than the predetermined value is not generated in the cap internal space.

In addition, a method of controlling a fluid ejecting apparatus according to the invention is a method of controlling a fluid ejecting apparatus that includes a fluid ejecting head that ejects fluid from a nozzle opening of a nozzle, and a cap that has a cap opening open toward the fluid ejecting head and an annular cap contact portion provided at a periphery of the cap opening, and, in order to achieve the above object, includes a contact step of bringing the cap contact portion of the cap into contact with the fluid ejecting head to thereby cover the nozzle opening with the cap opening, a cap suction step of sucking a cap internal space formed between the fluid ejecting head and an inner wall of the cap in a state where the cap is in contact with the fluid ejecting head, a pressure determination step of measuring a pressure in the cap internal space sucked in the cap suction step and determining whether a negative pressure that is equal to or higher than a predetermined value is generated in the cap internal space, and a cap sliding step of, when it is determined that the negative pressure that is equal to or higher than the predetermined value is not generated in the pressure determination step, sliding the cap contact portion over the fluid ejecting head in a state where the cap is in contact with the fluid ejecting head.

In the invention as configured above, the cap internal space formed between the fluid ejecting head and the inner wall of the cap is sucked in a state where the cap is in contact with the fluid ejecting head. Note that bringing the cap into contact with the fluid ejecting head is performed by the cap separate and contact means. The cap has the cap opening that is open toward the fluid ejecting head and the annular cap contact portion that is provided at the periphery of the cap opening. Then, the cap contact portion of the cap contacts the fluid ejecting head, so that the cap opening covers the nozzle opening. Thus, as described above, if the cap contact portion is not favorably adhered to the fluid ejecting head, there is a possibility that a sufficient negative pressure is not generated in the cap internal space.

In contrast to this, in the invention, a pressure in the sucked cap internal space is measured and it is determined whether the negative pressure that is equal to or higher than the predetermined value is generated in the cap internal space. Then, when it is determined that the negative pressure that is equal to or higher than the predetermined value is not generated in the cap internal space, the sliding action is performed so that the cap contact portion is made to slide over the fluid ejecting head in a state where the cap is in contact with the fluid ejecting head. Thus, even when the cap contact portion is not favorably adhered to the fluid ejecting head and poor adherence is occurring, by making the cap contact portion slide over the fluid ejecting head, it is possible to reduce the poor adherence to thereby obtain favorable adherence of the cap contact portion to the fluid ejecting head. Thus, a sufficient negative pressure may be generated in the cap internal space, and, in addition, clogging, or the like, may be efficiently removed.

In addition, the control means may determine whether the negative pressure that is equal to or higher than the predetermined value is generated while the suction action is being performed by the cap suction means. That is, this may be the configuration described later. With the thus configured control means, it is possible to suppress wasteful consumption of fluid, and also it is possible to reduce time required for removing clogging, or the like.

In addition, in the fluid ejecting apparatus in which the fluid ejecting head has a nozzle opening plane and the nozzle opening is open at the nozzle opening plane, the cap contact portion may contact the nozzle opening plane in a state where the cap is in contact with the fluid ejecting head, wherein the cap sliding means may reciprocally move the cap in a direction parallel to the nozzle opening plane to thereby make the cap contact portion slide over the fluid ejecting head. That is, in the invention as configured above, because the cap is reciprocally moved in a direction parallel to the nozzle opening plane to thereby make the cap contact portion slide over the fluid ejecting head, it is possible to obtain favorable adherence of the cap contact portion to the fluid ejecting head. Thus, in the above invention, a sufficient negative pressure may be generated in the cap internal space, and, in addition, clogging, or the like, may be efficiently removed. Hence, it is preferable.

Furthermore, in the above invention, when the cap contact portion is made to slide over the fluid ejecting head, the cap is reciprocally moved. That is, the cap, in the reciprocal movement, moves from a position (a sliding initiation position) at the time when the sliding is initiated in a predetermined direction and returns again to the sliding initiation position. Thus, the positional relationship between the fluid ejecting head and the cap contact portion remains unchanged before and after the cap contact portion slides. Thus, when the fluid ejecting apparatus is designed, it is not necessary to consider a difference in the positional relationship between the fluid ejecting head and the cap contact portion before and after the cap contact portion slides, and the design is easy and simple. Hence, the above invention is preferable.

In addition, the cap sliding means may perform the reciprocal movement of the cap multiple times. This is because, by performing the reciprocal movement of the cap multiple times, adherence of the cap contact portion to the fluid ejecting head may further effectively be favorable.

### BRIEF DESCRIPTION OF THE DRAWINGS

FIG. 1 is a perspective view that schematically shows a printer, which serves as a fluid ejecting apparatus.

FIG. 2 is a perspective view that schematically shows a maintenance unit.

FIG. 3 is a plan view for illustrating the configuration of the maintenance unit.

FIG. 4 is a plan view for illustrating the configuration of the maintenance unit.

FIG. 5 is a perspective view for illustrating the configuration of a driving mechanism of a slider.

FIG. 6 is a side view for illustrating the configuration of the driving mechanism of the slider.

FIG. 7 is a side view for illustrating the configuration of the driving mechanism of the slider.

FIG. 8 is a side view for illustrating the configuration of the driving mechanism of the slider.

FIG. 9 is a side view for illustrating a standby state of the slider.

FIG. 10 is a side view for illustrating a flushing state of the slider.

FIG. 11 is a side view for illustrating a capping state of the slider.

FIG. 12 is a view that shows the configuration of a cap member.

FIG. 13 is a view that shows the configuration of the cap member.

FIG. 14 is a view that shows the configuration of the maintenance unit according to a first embodiment.

FIG. 15 is a view that shows the configuration of the maintenance unit according to the first embodiment.

FIG. 16 is a view that illustrates the configuration and action of a guide groove and a positioning rod.

FIG. 17 is a view that illustrates the configuration and action of the guide groove and the positioning rod.

FIG. 18 is a view that illustrates the actions that can be performed by the maintenance unit according to the first embodiment.

FIG. 19 is a view that shows the configuration that performs a suction action in the first embodiment.

FIG. 20 is a flow chart of actions that are performed in the first embodiment.

FIG. 21 is a schematic view that shows a relationship between the suction action and a negative pressure detection timing.

FIG. 22 is a view that shows the configuration that performs a suction action in a second embodiment.

FIG. 23 is a flow chart of actions that are performed in the second embodiment.

### DESCRIPTION OF THE PREFERRED EMBODIMENTS

Prior to the description of an embodiment of the invention, a basic configuration of a fluid ejecting apparatus, which is an application target of the invention, will be described. After the above description, embodiments of the invention will be described.

Basic Configuration

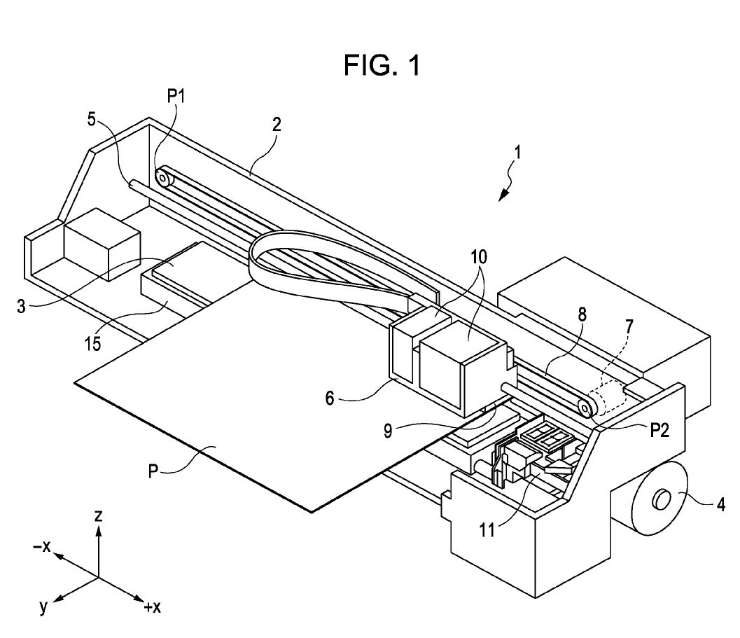

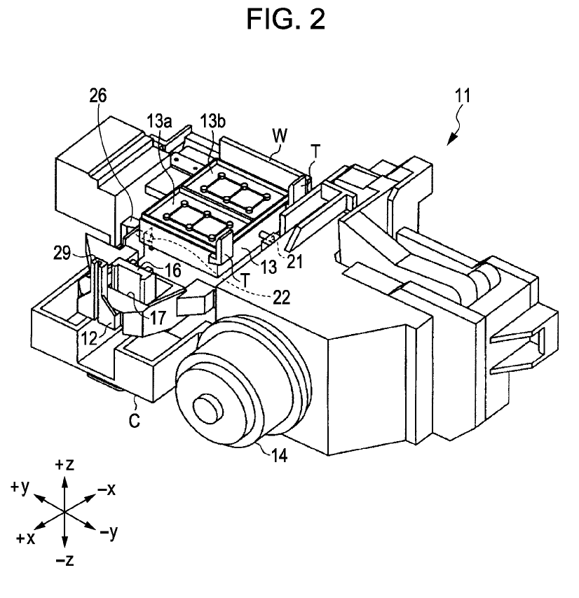

FIG. 1 is a perspective view that schematically shows a printer, which serves as the fluid ejecting apparatus. FIG. 2 is a perspective view that schematically shows a maintenance unit. As shown in FIG. 1, the printer 1, which serves as the fluid ejecting apparatus, includes a substantially rectangular-parallelepiped-shaped frame 2. A platen 3 is arranged in the frame 2 in the longitudinal direction (x direction) of the frame 2, and a recording paper is fed onto the platen 3 by a paper feed mechanism (not shown) that includes a paper feed motor 4.

A guide member 5 is provided on the frame 2 so as to extend parallel to the platen 3. A carriage 6 is fitted to and supported by the guide member 5, and is movable along the guide member 5. In addition, a carriage motor 7 is attached to the frame 2, and the carriage 6 is drivably connected to the carriage motor 7 through a timing belt 8, which is looped around a pair of pulleys P1 and P2. With the above configuration, as the carriage motor 7 drives, driving force of the carriage motor 7 is transmitted to the carriage 6 through the timing belt 8. The carriage 6, as it receives the driving force, is configured to reciprocally move in a main scanning direction (positive x direction and negative x direction) that is parallel to the platen 3 while being guided by the guide member 5.

A recording head 9, which serves as a fluid ejecting head, is provided at the lower face of the carriage 6. The recording head 9 has a planar nozzle forming face. Then, the nozzle forming face has a plurality of nozzles (not shown) that are formed so as to face the recording paper P. That is, the nozzle forming face corresponds to a nozzle opening plane according to the invention. Then, each nozzle is open at the nozzle opening plane.

In addition, as shown in FIG. 1, the carriage 6 is detachably loaded with an ink cartridge 10, which serves as a liquid storage portion. The ink cartridge 10 includes a plurality of partitioned storage chambers. The storage chambers respectively store inks (for example, pigment ink and reactive ink), which serve as fluids. That is, the printer 1 is of a so-called on-carriage type. Then, the inks stored in the ink cartridge 10 are supplied to the corresponding nozzles of the recording head 9. With the above configuration, as the ink cartridge 10 is loaded on the carriage 6, the inks stored in the ink cartridge 10 flow into the recording head 9. Then, the inks that have flown into the recording head 9 are pressurized by piezoelectric elements (not shown), and are ejected from the nozzle openings of the nozzles onto the recording paper P in the form of ink droplets to thereby form dots.

In addition, the recording head 9 is driven so as to discharge reactive ink after black ink or color ink (pigment ink) has been discharged. The reactive ink adheres to color ink on the recording paper P and then undergoes an agglutination reaction with the color ink to thereby enhance the color development and gloss of the color ink. In addition, the recording head 9 is controlled and driven so as to also discharge the ink on a paper face, to which black ink or color ink is not discharged, in order to enhance the gloss.

In the printer 1, a region, on which printing is performed in such a manner that the carriage 6 discharges ink droplets onto the recording paper P while being reciprocally moved, is determined as a printing region, which serves as an ejecting region. Furthermore, the printer 1 is provided with a non-printing region for capping the nozzles when printing is not performed. In the non-printing region, as shown in FIG. 1, the maintenance unit 11 is provided. The maintenance unit 11 is used to maintain a favorable discharged state from each of the nozzles by performing appropriate maintenance of the recording head 9.

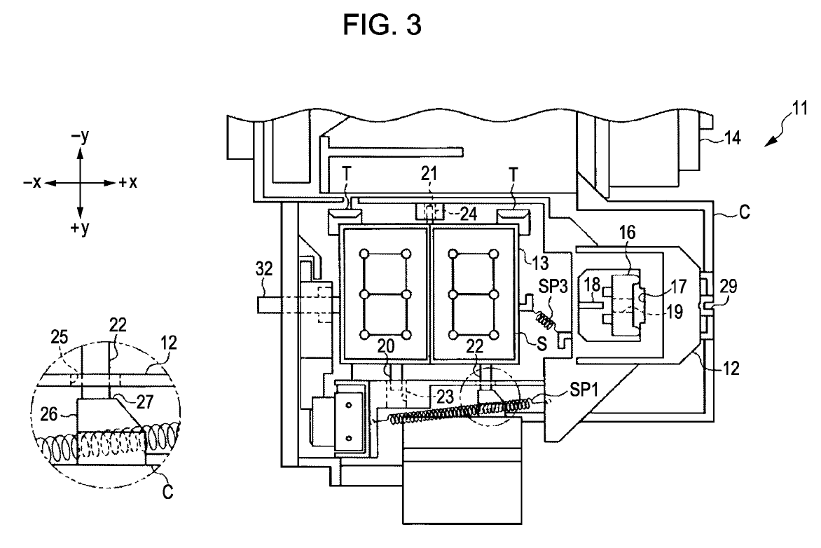

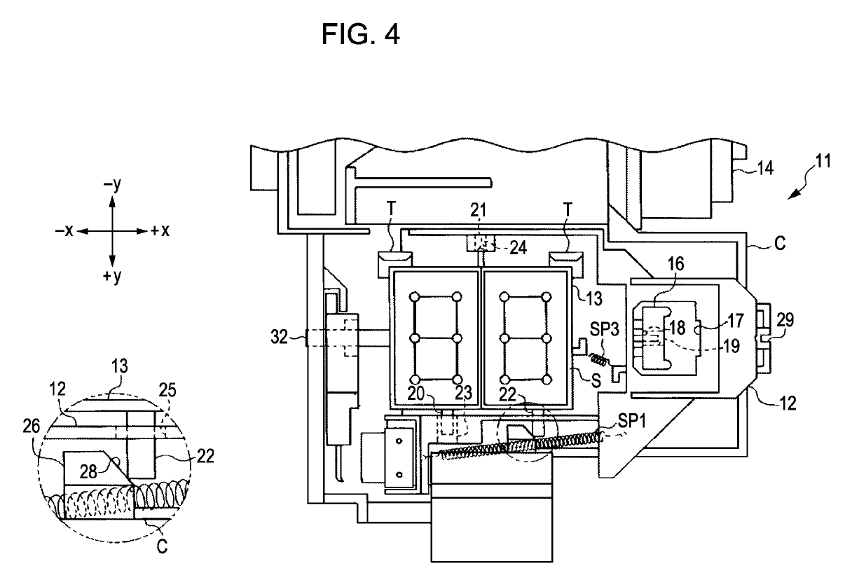

As shown in FIG. 2, a slider 12 is attached to a body case C of the maintenance unit 11 so that it is reciprocally movable laterally (positive x direction and negative x direction) through a spring member SP1 (see FIG. 3 or FIG. 4). A substantially rectangular-shaped cap member 13 is provided in the slider 12 to cap the nozzles of the recording head 9. The maintenance unit 11 is configured to cap the nozzles of the recording head 9 using an actuating mechanism, which will be described later, in such a manner that the cap member 13 is horizontally moved to be located immediately below the recording head 9 or the cap member 13 is raised or lowered to be brought into close contact with the recording head 9.

In addition, the inside of the cap member 13 is partitioned into two sections, and absorbents 13a and 13b are placed in the two sections, respectively. Then, a waste ink tank 15, shown in FIG. 1, is provided on the lower side of the platen 3. The waste ink tank 15 is connected to the bottom (not shown) of the cap member 13 through two tubes (not shown), which are respectively in fluid communication with the partitioned sections of the cap member 13, and a suction pump 14 (cap suction means). The inside of the waste ink tank 15 is partitioned into two sections, and the partitioned sections are connected to the two partitioned sections of the cap member 13, respectively.

That is, with the above configuration, it is possible to perform so-called cleaning such that pigment ink and reactive ink, which are stored in the ink cartridge 10, are separately absorbed by the absorbents 13a and 13b. and are respectively discarded to the waste ink tank 15. Note that the details of the cleaning will be described later.

In addition, as shown in FIG. 2, the maintenance unit 11 includes a wiper member W for wiping away ink that is adhered on the nozzle forming face of the recording head 9. The wiper member W is provided so as to be containable in the body case C in such a manner that it is moved by means of an driving mechanism (not shown).

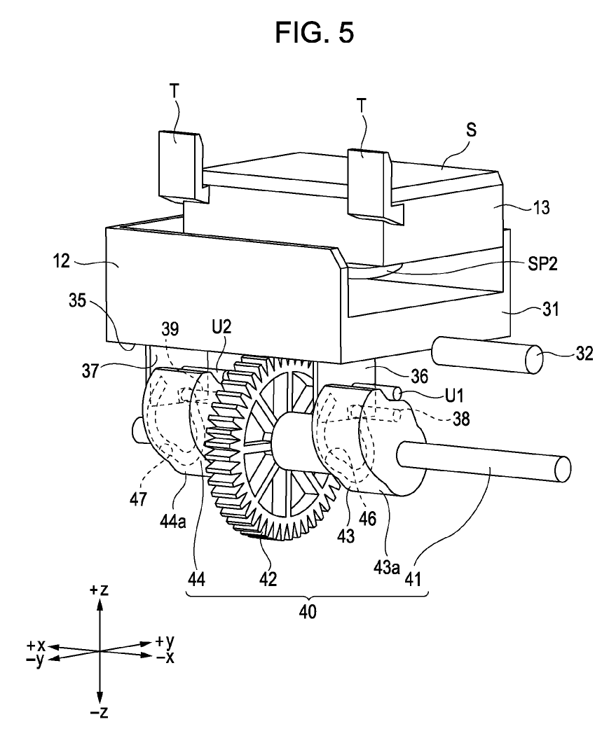

Next, the configuration of the above described maintenance unit 11 will be described with reference to FIG. 3 to FIG. 8. FIG. 3 and FIG. 4 are plan views for illustrating the configuration of the maintenance unit 11. FIG. 5 is a perspective view for illustrating the configuration of a driving mechanism of the slider 12.

As shown in FIG. 3, the maintenance unit 11 includes a slider guide 16 on the body case C. The slider guide 16 guides the slider 12. The slider guide 16 is inserted into an insertion opening 17 of the slider 12. In addition, a support rod 18 is formed on the slider 12 so as to extend rightward (positive x direction) into the insertion opening 17. Then, the slider guide 16 has a support groove 19 that is formed in correspondence with the support rod 18. The support groove 19 receives and supports the support rod 18, and is formed to extend through so that the support rod 18 is movable laterally (positive x direction and negative x direction). Furthermore, the support groove 19 is formed to extend longitudinally so that the support rod 18 is movable vertically (positive z direction and negative z direction). In addition, the support groove 19 contacts the support rod 18 at its upper end portion so as to restrict upward (positive z direction) movement of the support rod 18.

With the above configuration, the slider 12 is movable with respect to the body case C vertically (positive z direction and negative z direction) and laterally (positive x direction and negative x direction).

In addition, as described above, the slider 12 is fitted to the body case C through the spring member SP1, which serves as a first urging means. In this manner, the slider 12 is urged leftward (negative x direction) with respect to the body case C. Thus, when no force is applied to the slider 12, the insertion opening 17 of the slider 12 is in contact with the right face of the slider guide 16 of the body case C, as shown in FIG. 3. Note that the above state is referred to as reference position.

As shown in FIG. 5, the cap member 13 is fitted to the slider 12 through a spring member SP2, which serves as a second urging means. As shown in FIG. 3 or FIG. 4, the cap member 13 has flexibility, and includes a seal member S that contacts the recording head 9 and a pawl portion T, which serves as a support member, that contacts the recording head 9. Furthermore, the cap member 13 includes a support rod 20 that extends frontward (positive y direction), a support rod 21 that extends rearward (negative y direction) and a positioning rod 22, which serves as a positioning means, that extends frontward (positive y direction).

On the other hand, as shown in FIG. 3 or FIG. 4, the slider 12 has support grooves 23 and 24 and a guide groove 25, which serves as a guide means, which are formed in correspondence with these support rods 20 and 21 and the positioning rod 22. The support grooves 23 and 24 and the guide groove 25 respectively receive and support the support rods 20 and 21 and the positioning rod 22, and the support rods 20 and 21 and the positioning rod 22 are formed to extend longitudinally so that they are movable vertically (positive z direction and negative z direction). The support grooves 23 and 24 and the guide groove 25 respectively contact the support rods 20 and 21 and the positioning rod 22 at their upper ends so as to restrict upward (positive z direction) movement. In addition, movement of the support rods 20 and 21 and the positioning rod 22 in the positive x direction and in the negative x direction are restricted by the support grooves 23 and 24 and the guide groove 25. The support grooves 23 and 24 and the guide groove 25 are formed to have such depths that, when the cap member 13 moves frontward (positive y direction) or rearward (negative y direction), the support rods 20 and 21 and the positioning rod 22 do not come off.

With the above configuration, the cap member 13 is movable vertically (positive z direction and negative z direction) with respect to the slider 12. Furthermore, the cap member 13 is urged upward (positive z direction) by the spring member SP2, and the upward (positive z direction) movement of the cap member 13 is restricted by the support rods 20 and 21 and the positioning rod 22. In this manner, normally, as the cap member 13 is pressed downward (negative z direction) in a state where the cap member 13 is fully spaced apart from the slider 12 upward (positive z direction), the cap member 13 moves downward (negative z direction) in accordance with the pressing.

In addition, as shown in FIG. 3 or FIG. 4, a spring member SP3 is attached between the slider 12 and the right face of the cap member 13. The spring member SP3 is used to urge the cap member 13 toward the slider 12, that is, to the right front side (composite direction of the positive x direction and the positive y direction) and, thereby, the cap member 13 is always urged to the right front side with respect to the slider 12. The lateral (positive x direction and negative x direction) movement of the cap member 13 with respect to the slider 12 is restricted by the support grooves 23 and 24 as described above. Thus, the cap member 13 is urged frontward (positive y direction) with respect to the slider 12.

On the other hand, as shown in FIG. 3 or FIG. 4, the body case C includes a substantially trapezoidal protruding portion 26, which serves as a guide portion. The protruding portion 26 is formed so as to protrude from the body case C rearward (negative y direction), and faces and contacts the positioning rod 22 of the cap member 13.

Then, as shown in FIG. 3, when the slider 12 is located at the reference position, the positioning rod 22 of the cap member 13 contacts the end portion 27 of the protruding portion 26. In this state, the cap member 13 is supported by the protruding portion 26 through the positioning rod 22, and the movement of the cap member 13 is restricted.

Furthermore, when the slider 12 moves rightward (positive x direction) from the reference position, because the cap member 13 fitted to the slider 12 is urged by the spring member SP3 frontward (positive y direction) with respect to the slider 12, the positioning rod 22 moves to the right front side (composite direction of the positive x direction and the positive y direction) along the oblique portion 28 of the protruding portion 26. Then, as shown in FIG. 4, the positioning rod 22 is supported by the oblique portion 28 of the protruding portion 26. At this time, the cap member 13 is at rest in a state where the cap member 13 is slightly moved frontward (positive y direction) as compared with the state shown in FIG. 3. The state shown in FIG. 4 is referred to as set position.

With the above configuration, for example, as the recording head 9 contacts a contact portion 29, which is formed to extend from the slider 12, to thereby press the slider 12 rightward (positive x direction), the slider 12 moves rightward (positive x direction) and, in accordance with this, the cap member 13 moves to the set position. At this time, by the movement of the cap member 13 to the set position, the pawl portion T of the cap member 13 moves frontward (positive y direction) and then contacts the recording head 9. That is, the set position is a position at which the cap member 13 directly faces the nozzles of the recording head 9. In addition, the reference position is a position at which the cap member 13 is retracted from the path of the recording head 9 in the main scanning direction, that is, in the positive x direction and in the negative x direction.

Note that the guide groove 25 provided in the slider 12 is formed to have a size that is approximately 1.2 times larger than the size of the positioning rod 22 of the cap member 13. In this manner, it is possible to reduce abrasion when the positioning rod 22 contacts the guide groove 25, and also it is possible to avoid deterioration of movement of the cap member 13 in the positive y direction and in the negative y direction because of the abrasion.

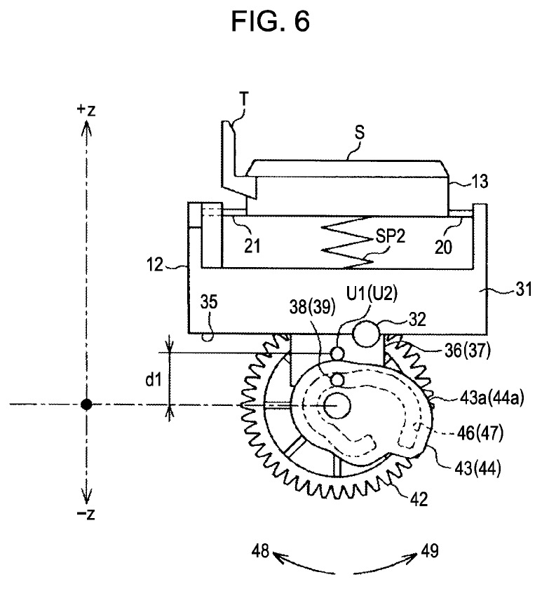

Next, the configuration of the driving mechanism of the slider 12 will be described with reference to the above described FIG. 5, and FIG. 6 to FIG. 8. FIG. 6 to FIG. 8 are side views for illustrating the configuration of the driving mechanism of the slider 12. In addition, FIG. 6 to FIG. 8 are side views of the slider 12 when viewed in the negative x direction.

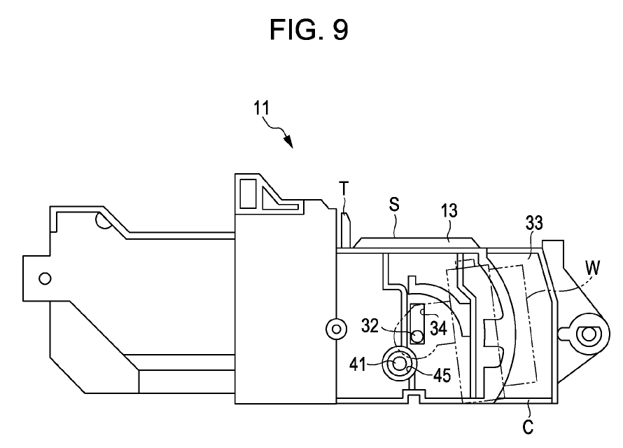

As shown in FIG. 5, a shaft 32 is formed at the lower portion of the side face 31 of the slider 12 so as to extend rightward (negative x direction). The shaft 32 is supported and inserted in a guide groove 34 (see FIG. 9) which serves as a guide means, that is formed to extend longitudinally vertically (positive z direction and negative z direction) from the side face 33 (see FIG. 9) of the body case C. In addition, the shaft 32 has such a length that the shaft 32 does not come off from the guide groove 34 when the slider 12 moves laterally (positive x direction and negative x direction) as shown in FIG. 4.

In addition, two plate-like plate portions 36 and 37 are formed at the bottom portion 35 of the slider 12. Sliding shafts 38 and 39 and contact shafts U1 and U2 are respectively formed on the plate portions 36 and 37 so as to extend rightward (negative x direction) in FIG. 5.

On the other hand, in the body case C, as shown in FIG. 5, a cam mechanism 40, which serves as a driving mechanism, is provided so as to be located below the slider 12. The cam mechanism 40 includes a shaft portion 41, a gear 42 and cam portions 43 and 44. The gear 42 is fixedly connected to the middle of the shaft portion 41. Furthermore, the cam portions 43 and 44 are fixedly connected to both end portions of the shaft portion 41 on which the gear 42 is located at the middle thereof. Thus, as the gear 42 rotates by the driving force received, the cam portions 43 and 44 also rotate in the same direction. Then, the cam mechanism 40 is configured so that both end portions of the shaft portion 41 are respectively inserted in a support hole 45 (see FIG. 9), provided on the side face of the body case C, and in a support hole (not shown) provided in the body case C, and are rotatably supported. Thus, the cam mechanism 40 is able to rotate about the shaft portion 41. In addition, the cam mechanism 40, as shown in FIG. 5, is fitted to the slider 12 in such a manner that the sliding shafts 38 and 39 of the plate portions 36 and 37 are inserted in sliding grooves 46 and 47, which are respectively formed in the cam portions 43 and 44. At this time, the contact shafts U1 and U2 are configured to slide over the side face 43a of the cam portion 43 and over the side face 44a of the cam portion 44, respectively.

Thus, when the cam mechanism 40 rotates about the shaft portion 41, the cam portions 43 and 44 rotate, so that the sliding shafts 38 and 39 slide along the sliding grooves 46 and 47. At this time, the contact shafts U1 and U2 are supported so as to be in slide contact with the side faces 43a and 44a of the cam portions 43 and 44. In this manner, the relative distance between the shaft portion 41 and the contact shaft U1 or U2 increases or decreases as the shaft portion 41 rotates. That is, because the shaft portion 41 of the cam mechanism 40 is supported by the body case C as described above, the slider 12 moves vertically (positive z direction and negative z direction) with respect to the body case C while the shaft 32 is being guided by the guide groove 34 of the body case C.

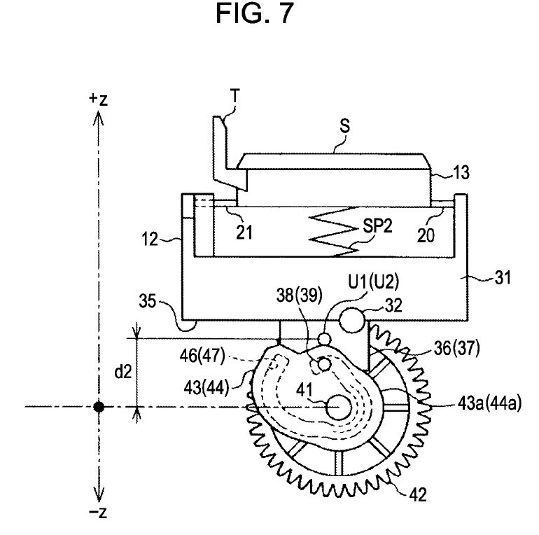

Then, driving force is transmitted from a driving motor (not shown), which is capable of rotating both in the forward direction and in the reverse direction, to the gear 42 of the cam mechanism 40 through a driving mechanism (not shown). Thus, for example, when the positional relationship between the sliding grooves 46 and 47 of the cam portions 43 and 44 and the sliding shafts 38 and 39 is established in a state shown in FIG. 6 (the relative distance between the shaft portion 41 and the contact shaft U1 or U2 is a relative distance d1), and when the driving motor rotates in the forward direction, the gear 42 receives the driving force from the driving motor and thereby rotates in a direction (clockwise direction) indicated by an arrow 48. Then, the sliding shafts 38 and 39 slide within the sliding grooves 46 and 47 and are guided, and then the sliding shafts 38 and 39 move up to the positions within the sliding grooves 46 and 47, as shown in FIG. 7. At this time, the contact shafts U1 and U2 slide along the side faces 43a and 44a of the cam portions 43 and 44 and are supported. Thus, the relative distance between the shaft portion 41 and the contact shaft U1 or U2 is a relative distance d2.

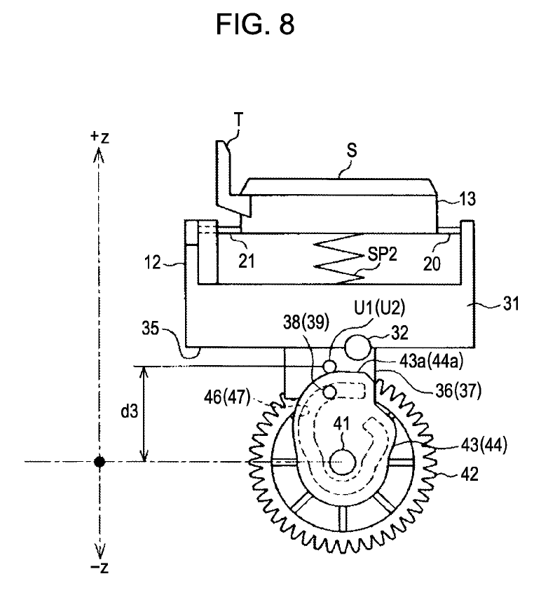

In addition, when the positional relationship between the sliding grooves 46 and 47 and the sliding shafts 38 and 39 is established in a state shown in FIG. 6 (the relative distance between the shaft portion 41 and the contact shaft U1 or U2 is a relative distance d1), and when the driving motor rotates in the reverse direction, the gear 42 receives the driving force from the driving motor and rotates in a direction (counterclockwise direction) indicated by an arrow 49. Then, the sliding shafts 38 and 39 slide within the sliding grooves 46 and 47 and are guided, and the sliding shafts 38 and 39 move up to the positions within the sliding grooves 46 and 47 as shown in FIG. 8. At this time, the contact shafts U1 and U2 slide along the side faces 43a and 44a of the cam portions 43 and 44 and are supported. Thus, the relative distance between the shaft portion 41 and the contact shaft U1 or U2 is a relative distance d3.

The order of these relative distances d1, d2, and d3 is relative distance d1<relative distance d2<relative distance d3. Note that the state shown in FIG. 6 (relative distance d1) is referred to as standby state, the state shown in FIG. 7 is referred to as flushing state (relative distance d2), and the state shown in FIG. 8 (relative distance d3) is referred to as capping state. Then, the driving motor, in accordance with a control signal from a control circuit (not shown) provided in the printer 1, is able to rotate in the forward or in the reverse direction and further maintain the respective states, that is, the standby state, the flushing state and the capping state, by stopping the driving of the driving motor.

In addition, the wiper member W, when the slider 12 is in the standby state (the state shown in FIG. 6), is located in the body case C. As the slider 12 moves to the flushing state (the state shown in FIG. 7), the wiper member W moves out of the body case C and is located so as to be able to contact the recording head 9.

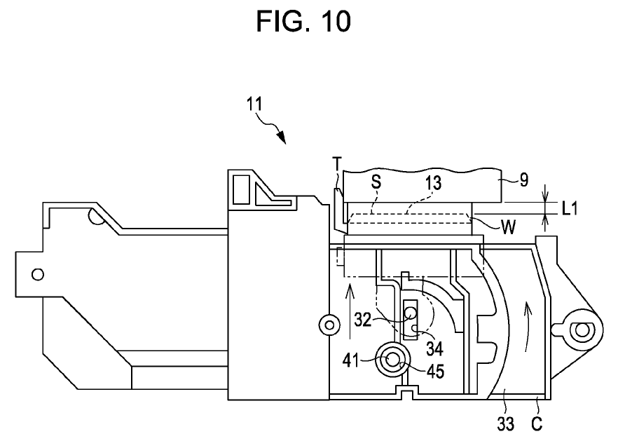

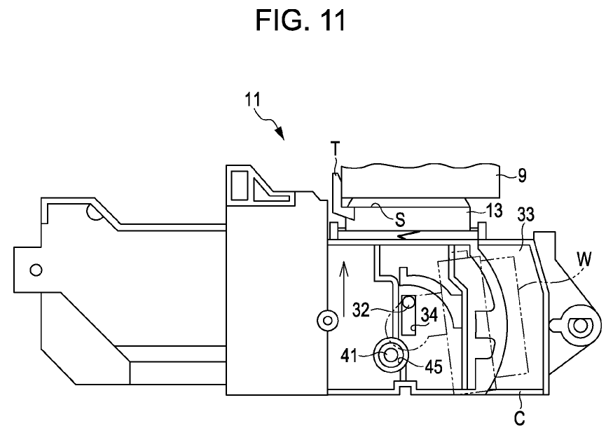

Next, the action of the above configured maintenance unit 11 will be described with reference to FIG. 9 to FIG. 11. FIG. 9 is a side view for illustrating the standby state of the slider 12. FIG. 10 is a side view for illustrating the flushing state of the slider 12. FIG. 11 is a side view for illustrating the capping state of the slider 12.

As shown in FIG. 9, in the maintenance unit 11, when the slider 12 is in the standby state (relative distance d1), the slider 12 is located at the reference position shown in FIG. 3.

Then, when the printer 1 shown in FIG. 1 performs the flushing operation in which ink is idly discharged from the nozzles of the recording head 9 toward the cap member 13, the carriage 6 is moved to the non-printing region and the recording head 9 is brought into contact with the contact portion 29 of the slider 12. Then, as the recording head 9 contacts the contact portion 29, the slider 12 moves to the set position as shown in FIG. 4. In accordance with this, the pawl portion T moves frontward (positive y direction) and then contacts and supports the recording head 9. Then, the cap member 13 is able to directly face the recording head 9.

In addition, at this time, the printer 1, when it brings the recording head 9 into contact with the contact portion 29 of the slider 12, moves the slider 12 from the standby state to the flushing state. In accordance with this, the wiper member W moves out of the body case C and moves to a position at which the wiper member W is able to contact the recording head 9. Then, the recording head 9 passes over the wiper member W in order to contact the contact portion 29 of the slider 12, so that ink that is adhered on the nozzle forming face of the recording head 9 is wiped away. Then, when the slider 12 has moved to the flushing state, the driving motor stops and, as shown in FIG. 10, maintains the flushing state. At this time, the cap member 13 faces the recording head 9 in a state where a gap L1 is formed. Then, the printer 1 is able to perform maintenance of the nozzles of the recording head 9 by performing the flushing operation in this state.

Furthermore, when the recording head 9 is capped from this state, the printer 1 moves the slider 12 from the flushing state to the standby state and, further, moves the slider 12 to the capping state. In this manner, as shown in FIG. 11, because the slider 12 further moves upward (positive z direction), the seal member S of the cap member 13 contacts the recording head 9 and then caps the nozzle forming face, thus preventing ink in the nozzles from drying.

In addition, in a state where the cap member 13 caps the recording head 9, the suction pump 14 is driven to perform so-called cleaning in which ink, which serves as fluid, bubbles, or dust in the recording head 9, nozzle clogging, or the like, is sucked through the cap member 13. Here, through description of the configuration of the cap member 13, the cleaning will be described.

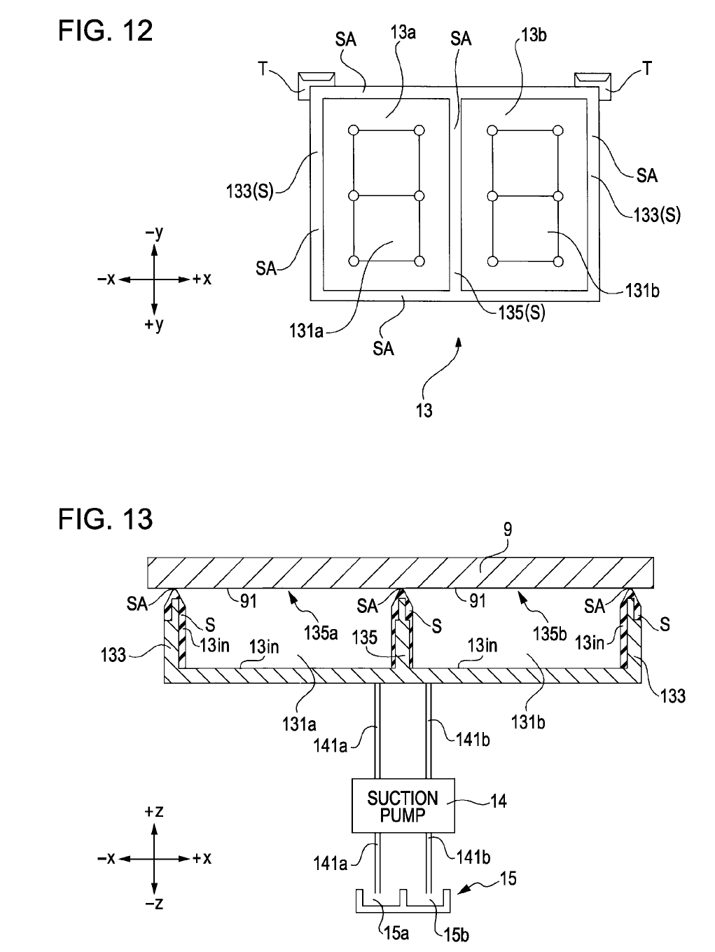

FIG. 12 and FIG. 13 are views that show the configuration of the cap member 13. The cap member 13 includes a cap case 133. In addition, a partition wall 135 is provided inside the cap case 133, so that the inside of the cap case 133 is partitioned into two sections. Each of the two partitioned sections inside the cap case 133 is open toward the recording head, and two cap openings 135a and 135b are formed. In addition, the seal member S, made of an elastic material such as elastomer, is formed at the portions of the cap case 133 and the partition wall 135, facing the recording head 9. That is, the seal member S is provided at each of the peripheries of the cap openings 135a and 135b. Thus, in the capping state, the seal member S of the cap member 13 contacts the nozzle forming face 91 of the recording head 9, and the cap openings 135a and 135b cover the nozzle openings of the nozzle forming face 91. In the capping state, the seal member S contacts the nozzle forming face 91 through annular seal contact portions SA, which are provided at the peripheries of the cap openings 135a and 135b. In this way, the cap member 13 corresponds to a “cap” according to the invention, and the seal contact portion SA corresponds to a “cap contact portion” according to the invention.

In addition, as shown in FIG. 13, in a state where the cap member 13 is in contact with the nozzle forming face 91 of the recording head 9 (capping state), two cap internal spaces 131a and 131b are formed between the nozzle forming face 91 and the inner wall 13 in of the cap member 13. Note that the absorbents 13a and 13b are respectively placed in the cap internal spaces 131a and 131b; however, the absorbents 13a and 13b are not shown in FIG. 13.

The waste ink tank 15 is connected to the bottom portion of the cap case 133 through the two tubes 141a and 141b that respectively communicate with the cap internal spaces 131a and 131b of the cap case 133. The inside of the waste ink tank 15 is partitioned into two waste ink storages 15a and 15b. Then, the waste ink storages 15a and 15b are respectively in fluid communication with the cap internal spaces 131a and 131b of the cap case 133. In addition, the suction pump 14 is arranged between the cap internal spaces 131a and 131b and the waste ink tank 15.

The suction pump 14 (cap suction means) is able to generate a negative pressure in the cap internal spaces 131a and 131b by sucking the cap internal spaces 131a and 131b. Thus, by actuating the suction pump 14 in the capping state, it is possible to perform so-called cleaning in which ink, bubbles, or dust in the nozzles covered with the cap member 13, nozzle clogging, or the like, is sucked. In this manner, black ink and color ink that are sucked through the cap member 13 are sent through one of the two tubes to one of the two waste ink storages of the waste ink tank 15, and reactive ink is sent through the other one of the two tubes to the other one of the two waste ink storages of the waste ink tank 15.

Thus, in the printer 1 (fluid ejecting apparatus) in a state where the cap member 13 is in contact with the recording head 9 (fluid ejecting head), the nozzles are sucked by the suction pump (cap suction means) to thereby suck ink, bubbles or dust in the nozzles, nozzle clogging, or the like. Specifically, in a state where the seal contact portions SA of the cap member 13 are in contact with the nozzle forming face 91 (nozzle opening plane) of the recording head 9, the cap internal spaces 131a and 131b, which are formed between the nozzle forming face 91 and the inner wall 13 in of the cap member 13, are sucked to thereby generate a negative pressure in the cap internal spaces 131a and 131b. Thus, ink, or the like, in the nozzles are removed. Incidentally, the cap member 13 contacts the nozzle forming face 91 of the recording head 9 through the seal contact portions SA of the peripheries of the cap openings 135a and 135b. Thus, in order to generate a sufficient negative pressure in the cap internal spaces 131a and 131b for removing ink, or the like, it is necessary that the seal contact portions SA are in close contact with the nozzle forming face 91.

However, when the cap internal spaces 131a and 131b are sucked, there have been cases in which such poor adherence that the seal contact portions SA are insufficiently adhered to the recording head 9 (for example, such poor adherence that the seal contact portions SA partially do not closely contact the nozzle forming face 91) occurs. Then, because of the above poor adherence, there have been cases in which a sufficient negative pressure cannot be generated in the cap internal space 131a or 131b. As a result, this may cause a problem that ink, or the like, in the nozzles cannot sufficiently be removed, or the like. Then, the technology that enables a sufficient negative pressure to be generated in the cap internal spaces by enhancing the adherence of the cap contact portion to the ink jet head will be described in the following embodiment.

### First Embodiment

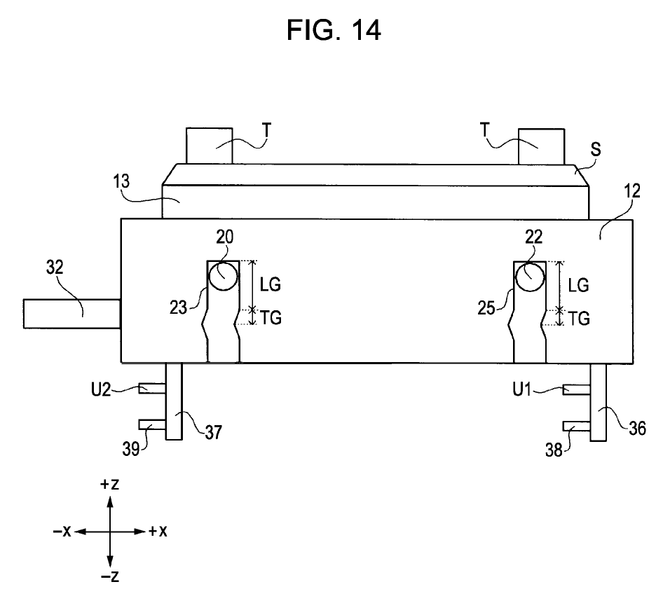

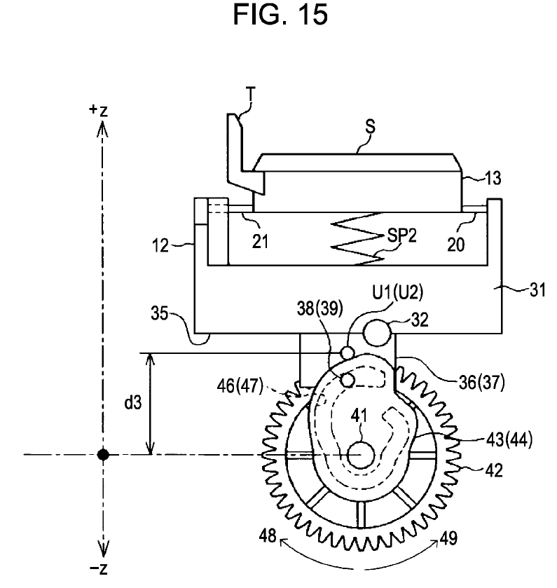

FIG. 14 and FIG. 15 are views that show the configuration of the maintenance unit according to the first embodiment. In addition, FIG. 15 shows the configuration of the maintenance unit 11 in the capping state. Then, the maintenance unit 11 according to the first embodiment, as will be described below, is able to perform a sliding action in which the seal contact portions SA are made to slide over the nozzle forming face 91 in such a manner that the cam portions 43 and 44 are rotated from the capping state in a direction (clockwise direction) indicated by the arrow 48 about the shaft portion 41.

In the maintenance unit 11 according to the first embodiment, the cap member 13 includes the support rods 20 and 21 and the positioning rod 22, while, on the other hand, the slider 12 has the support grooves 23 and 24 and a positioning groove 25 that are formed in correspondence with the support rods 20 and 21 and the positioning rod 22. Then, the support grooves 23 and 24 and the guide groove 25 respectively receive and support the support rods 20 and 21 and the positioning rod 22. Thus, the cap member 13 moves relative to the slider 12 while being guided by the support grooves 23 and 24 and the guide groove 25 that are formed in the slider 12. The point that the movement of the cap member is performed while being guided by the support grooves 23 and 24 and the guide groove 25 in this manner is common between the first embodiment and the above described basic configuration. However, the cap member 13 according to the basic configuration is guided only in the z direction (vertical direction). In contrast, the cap member 13 according to the first embodiment differs from that of the basic configuration in that the cap member 13 is guided in the z direction (vertical direction) and in the x direction (lateral direction).

In the first embodiment, the support grooves 23 and 24 and the guide groove 25 are similar in shape one another. Then, the action of the support groove 23 and the support rod 20 that is inserted and supported by the support groove 23, the action of the support groove 24 and the support rod 21 that is inserted and supported by the support groove 24, and the action of the guide groove 25 and the positioning rod 22 that is inserted and supported by the guide groove 25 are the same one another. Then, in the following description, the action of the guide groove 25 and the positioning rod 22 that is inserted and supported by the guide groove will be mainly described, and description of the action of the support groove 23 and the support rod 20 that is inserted and supported by the support groove 23 and the action of the support groove 24 and the support rod 21 that is inserted and supported by the support groove 24 will be omitted.

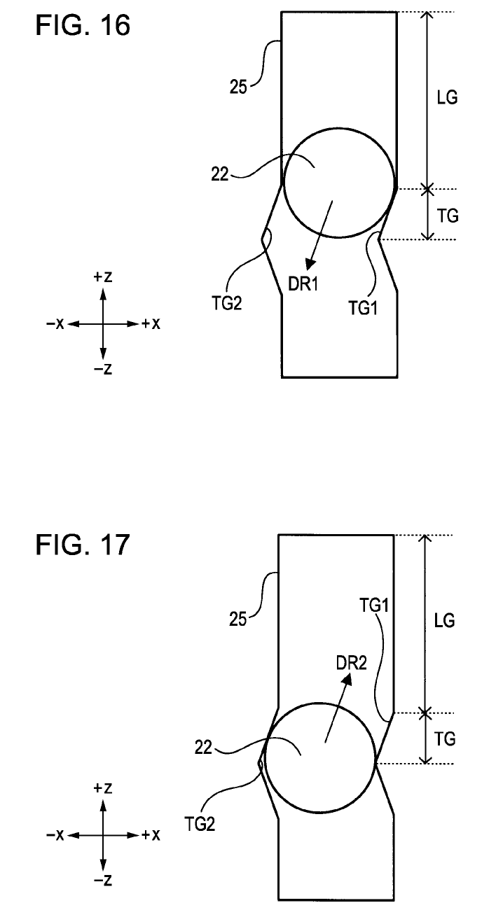

FIG. 16 and FIG. 17 are views that illustrate the configuration and action of the guide groove and the positioning rod. The guide groove 25 includes a vertical guide portion LG that is parallel to the z direction and a lateral guide portion TG that connects the vertical guide portion LG from the downstream side in the negative z direction. Then, the lateral guide portion TG extends not only in the z direction but also in the x direction. More specifically, in z-x plane, each of lateral guide portion edges TG1 and TG2 at both ends of the lateral guide portion TG in the x direction is inclined with respect to the z direction. Thus, when the positioning rod 22 moves from the state shown in FIG. 16 in the negative z direction, the positioning rod 22 contacts the lateral guide portion edge TG1 of the guide groove 25 and is guided by the lateral guide portion edge TG1 in a direction DR1. Here, the direction DR1 is parallel to the lateral guide portion edge TG1 and is a downward direction in FIG. 16. On the other hand, when the positioning rod 22 moves from the state shown in FIG. 17 in the positive z direction, the positioning rod 22 contacts the lateral guide portion edge TG2 of the guide groove 25 and is guided by the lateral guide portion edge TG2 in a direction DR2. Here, the direction DR2 is parallel to the lateral guide portion edge TG2 and is an upward direction in FIG. 17.

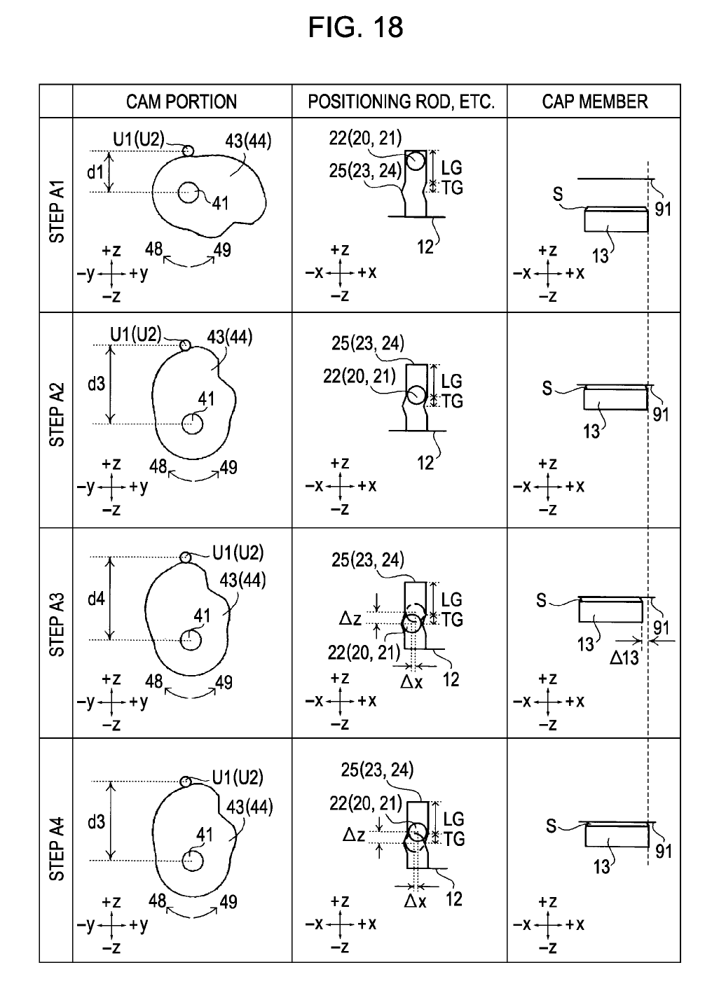

FIG. 18 is a view that illustrates the actions (contact action, sliding action) that can be performed by the maintenance unit according to the first embodiment. Each column of “STEP A1” to “STEP A4” in the drawing shows the states of the “cam portions 43 and 44”, “positioning rod, and the like” and “cap member” in each step. Note that the support rods 20 and 21 and the positioning rod 22 are collectively referred to as positioning rod and the like. In addition, the support grooves 23 and 24 and the guide groove are collectively referred to as guide groove and the like.

Here, the process from the standby state shown in the column “STEP A1” to the capping state shown in the column “STEP A2” in such a manner that the cam portions 43 and 44 rotate in a direction 49 (counterclockwise direction) will be considered. At first, in the standby state, the relative distance between the contact shaft U1 or U2 and the shaft portion 41 is a relative distance d1. In addition, the positioning rod and the like 20, 21 and 22 are in contact with the upper end portions of the guide groove and the like 23, 24 and 25 in the positive z direction. Then, the cap member 13 is spaced apart from the nozzle forming face 91.

As the cam portions 43 and 44 initiate rotation from the standby state shown in the column “STEP A1” in the direction 49 (counterclockwise direction), the relative distance between the contact shaft U1 or U2 and the shaft portion 41 increases. Thus, as the cam portions 43 and 44 rotate, the slider 12 moves in the positive z direction. In addition, the cap member 13 that is connected to the slider 12 through the spring member SP2 from the downstream side in the positive z direction also moves in the positive z direction as the slider 12 moves in the positive z direction. Furthermore, the nozzle forming face 91 is arranged on the downstream side of the cap member 13 in the positive z direction. Thus, while the cam portions 43 and 44 are rotating, the cap member 13 contacts the nozzle forming face 91 and stops moving in the positive z direction. On the other hand, the slider 12, after it has contacted the nozzle forming face 91 of the cap member 13, still continues to move in the positive z direction. That is, the cap member 13, after it has contacted the nozzle forming face 91, moves relative to the slider 12 as the cam portions 43 and 44 rotate. In addition, as the cap member 13 moves relative to the slider 12, the spring member SP2 progressively contracts.

As described above, the movement of the cap member 13 relative to the slider 12 is performed while being guided by the guide groove and the like, that is, the support grooves 23 and 24 and the guide groove 25. Thus, after the cap member 13 has contacted the nozzle forming face 91, the positioning rod and the like 20, 21 and 22 of the cap member 13 are guided by the vertical guide portions LG of the guide groove and the like 23, 24 and 25 to move in the negative z direction. Meanwhile, the cap member 13 in itself is in contact with the nozzle forming face 91 and does not move. Then, the relative distance between the contact shaft U1 or U2 and the shaft portion 41 is a relative distance d3, and the cap member 13 caps the nozzle openings of the nozzle forming face 91 (step A2). At this time, the guide groove and the like 23, 24 and 25 each are located at the end portion of the vertical guide portion LG in the negative z direction, that is, the boundary between the vertical guide portion LG and the lateral guide portion TG. In addition, in the capping state, the cap member 13 is urged toward the nozzle forming face 91 by a force corresponding to the amount by which the spring member SP2 is contracted as the cap member 13 moves relative to the slider 12. In this way, the maintenance unit 11 performs a contact action by performing the action of step A2.

In addition, the maintenance unit 11 is able to perform a sliding action in which the seal contact portions SA are made to slide over the nozzle forming face 91 in order to ensure adherence of the seal contact portions SA to the nozzle forming face 91 in the capping state. Specifically, this is as follows.

In the sliding action, after the cam portions 43 and 44 are further rotated from the capping state shown in the column “STEP A2” to the state shown in the column “STEP A3” in the direction 49 (counterclockwise direction), the cam portions 43 and 44 are rotated from the state shown in the column “STEP A3” to the capping state shown in the column “STEP A4” in the direction 48 (clockwise direction).

In the first embodiment, the side faces of the cam portions 43 and 44 are configured to increase a distance from the shaft portion 41 as they go from the contact positions of the contact shafts U1 and U2 in the capping state toward the upstream side in the direction 49. Thus, as the cam portions 43 and 44 initiate rotation from the capping state in the direction 49, the relative distance between the contact shaft U1 or U2 and the shaft portion 41 increases. Thus, as the cam portions 43 and 44 rotate, the slider 12 moves in the positive z direction. At this time, because the cap member 13 contacts the nozzle forming face 91, movement of the cap member 13 in the positive z direction is restricted. As a result, the cap member 13 moves relative to the slider 12 while being guided by the guide groove and the like, that is, the support grooves 23 and 24 and the guide groove 25. Incidentally, in the capping state, the positioning rod and the like 20, 21 and 21 of the cap member 13 each are located at the boundary between the vertical guide portion LG and the lateral guide portion TG. Thus, in the sliding action, the positioning rod and the like 20, 21 and 22 of the cap member 13 move in the negative z direction by being guided by the lateral guide portions TG of the guide groove and the like 23, 24 and 25.

In this way, the positioning rod and the like 20, 21 and 22 are guided by the lateral guide portions TG, while the cam portions 43 and 44 rotate in the direction 49 until the relative distance between the contact shaft U1 or U2 and the shaft portion 41 becomes a relative distance d4. In this manner, the positioning rod and the like 20, 21 and 22 move relative to the slider 12 from the capping state in the negative z direction by Δz and in the negative x direction by Δx. Here, the relative distance d4 is greater than the relative distance d3. Then, in correspondence with the movement of the positioning rod and the like 20, 21 and 22 in the negative x direction, the cap member 13 moves relative to the nozzle forming face 91 in the negative x direction by Δ13 while the cap member 13 remains in contact with the nozzle forming face 91 through the seal contact portions SA. That is, the seal contact portions SA are made to slide over the nozzle forming face 91. Note that, because the cap member 13 has been already in contact with the nozzle forming face 91 in the capping state, the cap member 13 never moves in the positive z direction in the sliding action.

In the sliding action, furthermore, the cam portions 43 and 44 are rotated in the direction 48 (clockwise direction) from the state shown in the column “STEP A3” to the capping state shown in the column “STEP A4”. Thus, the positioning rod and the like 20, 21 and 22 move relative to the slider 12 from the state shown in “STEP A3” in the positive z direction by Δz and in the positive x direction by Δx. Then, in correspondence with the movement of the positioning rod and the like 20, 21 and 22 in the positive x direction, the cap member 13 moves relative to the nozzle forming face 91 in the positive x direction by Δ13 while the cap member 13 remains in contact with the nozzle forming face 91 through the seal contact portions SA. That is, the seal contact portions SA are made to slide over the nozzle forming face 91. In this way, the maintenance unit 11 performs a sliding action by performing the action of step A2 and the action of step A4.

Thus, in the first embodiment, the slider 12, the positioning rod and the like 20, 21 and 22 that are respectively inserted in the guide groove and the like 23, 24 and 25 of the slider 12, and the cam mechanism 40, which serves as the driving mechanism, function as “cap separate and contact means”, “cap sliding means” according to the invention.

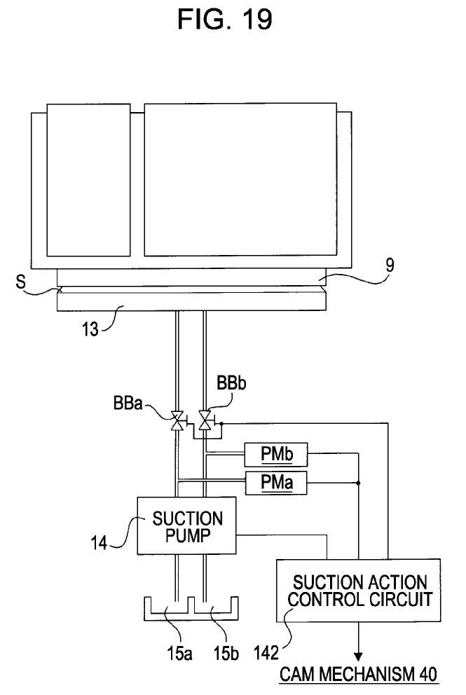

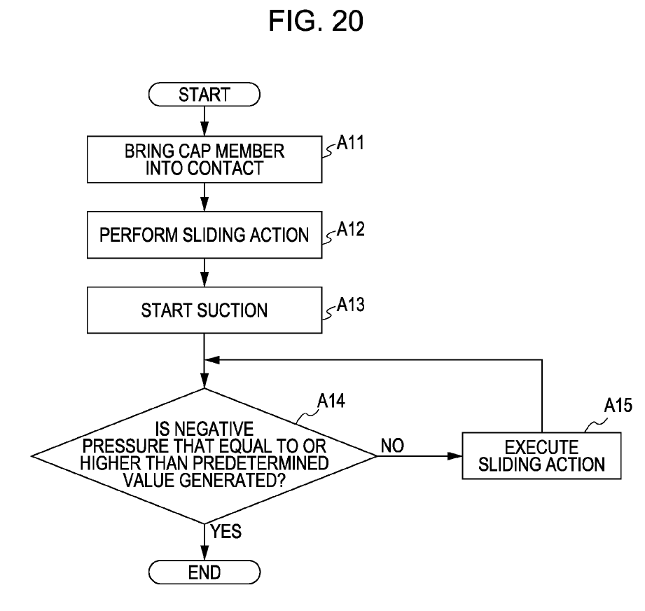

FIG. 19 is a view that shows the configuration that performs the suction action in the first embodiment of the invention. In addition, FIG. 20 is a flow chart of the actions that are performed in the first embodiment of the invention. In the first embodiment, valves BBa and BBb are provided between the cap member 13 and the suction pump 14. That is, the valve BBa is provided between the cap internal space 131a and the suction pump 14, and the valve BBb is provided between the cap internal space 131b and the suction pump 14. Furthermore, a manometer PMa is provided between the valve BBa and the suction pump 14, and a manometer PMb is provided between the valve BBb and the suction pump 14. That is, the manometer PMa monitors a pressure in the cap internal space 131a in a state where the valve BBa is open, and the manometer PMb monitors a pressure in the cap internal space 131b in a state where the valve BBb is open. Then, a suction action control circuit 142 controls the suction pump 14, the valves BBa and BBb and the manometers PMa and PMb to perform the suction action. In addition, the suction action control circuit 142 (control means) is able to control the cam mechanism 40 and, as will be described below, drives the cam mechanism 40 on the basis of pressure values indicated by the manometers PMa and PMb to thereby make the maintenance unit 11 perform the sliding action, and the like.

The flow shown in FIG. 20 will be described. In step A11, the cap member 13 is brought into contact with the nozzle forming face 91 of the recording head 9 through the seal contact portions SA (cap contact step). Then, the sliding action is performed in step A12, so that the seal contact portions SA are made to slide over the recording head 9. This sliding action is the same as the actions from step A2 to step A4 shown in FIG. 18. Then, in step A13, driving of the suction pump 14 is initiated, and the valves BBa and BBb are opened. Thus, the cap internal spaces 131a and 131b are sucked by the suction pump 14 (cap suction means) (cap suction step).

In addition, in the first embodiment, as described above, pressures in the cap internal spaces 131a and 131b are respectively monitored by the manometers PMa and PMb. Then, the suction action control circuit 142, when a predetermined time t1 has elapsed since the suction pump 14 has initiated the suction, determines whether a negative pressure Pth that is equal to or higher than a predetermine value is generated in each of the cap internal spaces 131a and 131b (step A14). That is, the suction action control circuit 142 determines whether a pressure that is lower than a pressure that is obtained by subtracting a negative pressure Pth from the atmospheric pressure is generated in each of the cap internal spaces 131a and 131b (pressure determination step). Then, when it is determined that a negative pressure that is equal to or higher than a predetermined value is not generated in any one of the cap internal spaces 131a and 131b (when it is determined “NO” in step A14), the process proceeds to step A15, and the suction action control circuit 142 instructs the maintenance unit 11 to perform the sliding action (cap sliding step). In addition, when a negative pressure that is equal to or higher than a predetermined value is generated in each of the cap internal spaces 131a and 131b, the suction action is further continued for a predetermined time and then the suction action is completed.

In this way, in the first embodiment, pressures in the cap internal spaces 131a and 131b are respectively monitored (measured) by the manometers PMa and PMb while the suction action is being performed by the suction pump 14 (step A14). That is, the first embodiment is configured to be able to detect whether a sufficient negative pressure is generated in each of the cap internal spaces 131a and 131b by providing the manometers PMa and PMb. Then, when a negative pressure that is equal to or higher than a predetermined value is not generated, it is determined that poor adherence is occurring in the seal contact portions SA to thereby perform the sliding action (step A15). Thus, even when the seal contact portions SA are not favorably adhered to the recording head 9 and poor adherence is occurring, by performing steps A14 and A15, it is possible to suppress poor adherence between the seal contact portions SA of the cap member 13 and the nozzle forming face 91 of the recording head 9. Hence, it is preferable. Thus, a sufficient negative pressure may be generated in each of the cap internal spaces 131a and 131b, and, in addition, clogging, or the like, may be effectively removed.

Incidentally, the timing (negative pressure detection timing) at which the suction action control circuit 142 determines whether a negative pressure that is equal to or higher than a predetermined value is generated in each of the cap internal spaces 131a and 131b is not limited to time t1 during the suction action. That is, for example, the suction action control circuit 142 may monitor a pressure in each of the cap internal spaces 131a and 131b after the suction action and may determine whether a negative pressure that is equal to or higher than a predetermined value is generated. However, as will be described below, the timing, at which negative pressure detection is performed by the suction action control circuit 142, is preferably during the suction action.

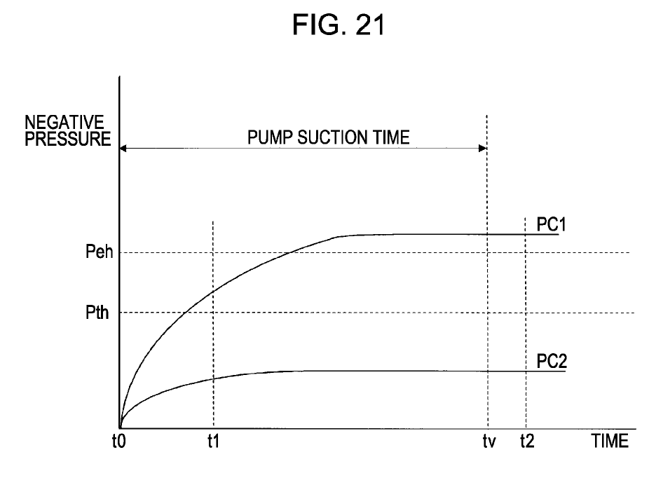

FIG. 21 is a schematic view that shows a relationship between the suction action and the negative pressure detection timing. In the drawing, the abscissa axis represents time, and the ordinate axis represents a negative pressure. A negative pressure curve PC1 is formed by plotting a pressure in the cap internal space 131a or 131b when the adherence of the seal contact portions SA is favorable. A negative pressure curve PC2 is formed by plotting a pressure in the cap internal space 131a or 131b when the adherence of the seal contact portions SA is poor. That is, the drawing shows the case in which the suction action of the cap internal spaces 131a and 131b is initiated at time t0 (step A13) and, further, the suction action is continuously performed until time tv (that is, during pump suction time). As shown in the drawing, any negative pressure curves PC1 and PC2 show that a negative pressure tends to increase with time.

Here, the case in which the negative pressure detection timing is at time t2 will be considered. The time t2 corresponds to the time after the suction action has been completed. Thus, in order to remove clogging, or the like, by the suction action being performed, it is necessary that, a negative pressure that is equal to or higher than a negative pressure Peh is generated in each of the cap internal spaces 131a and 131b during the suction action. Here, the negative pressure Peh is a minimum value of a negative pressure that is necessary to remove nozzle clogging, or the like. Thus, detecting whether a sufficient negative pressure is generated at time t2 is determining whether a negative pressure measured by each of the manometers PMa and PMb is equal to or higher than the negative pressure Peh.

Next, the case in which the negative pressure detection timing is at time t1 will be considered. The time t1 corresponds to the time at which the suction action is being performed. In such a case, when it is determined whether clogging, or the like, is removed by the suction action being performed, it is sufficient that it is determined whether a negative pressure in each of the cap internal spaces 131a and 131b is equal to or higher than the negative pressure Pth that is smaller than the negative pressure Peh. This is because, as shown in the drawing, the negative pressure curve PC1 is higher than the negative pressure Pth at time t1, while the negative pressure curve PC2 is smaller than the negative pressure Pth at time t2. In addition, as described above, the negative pressure curve PC1 corresponds to the case in which clogging, or the like, can be removed favorably without occurrence of poor adherence, and the negative pressure curve PC2 corresponds to the case in which poor adherence is occurring and clogging, or the like, cannot be removed favorably. Thus, detecting whether a sufficient negative pressure is generated at time t1 is sufficiently performed if it is determined whether a negative pressure measured by each of the manometers PMa and PMb is equal to or higher than the negative pressure Pth.

In this way, at time t1 at which the lapse of time from the initiation of the suction action is relatively short, that is, at the stage at which a large negative pressure is not generated in each of the cap internal spaces 131a and 131b, occurrence of poor adherence in the seal contact portions SA may be determined.

Incidentally, as described above, ink (fluid) is supplied from the ink cartridge 10 to each of the nozzles of the recording head 9. Thus, when a negative pressure is generated in each of the cap internal spaces 131a and 131b in order to remove clogging, or the like, portion of ink supplied to the recording head 9 flows out toward the suction pump 14 because of the negative pressure. Then, the amount of ink flowing out increases as the negative pressure generated in each of the cap internal spaces 141a and 141b increases or as the duration in which the negative pressure is generated in each of the cap internal spaces 141a and 141b increases. However, ink also flows out when the poor adherence is occurring as in the case of the negative pressure curve PC2; however, a sufficient negative pressure cannot be obtained and, therefore, clogging cannot be removed. Thus, ink is wastefully consumed. Then, in terms of ink saving, it is preferable to reduce outflow of ink as much as possible and to suppress wasteful ink consumption.

Then, the above discussed negative pressure detection timing is more preferable at time t1 during the suction action than at time t2 after the suction action has been completed. This is because, in order to suppress outflow of ink from the recording head 9, a period of time until the negative pressure detection timing is preferably short, and a negative pressure that is generated in each of the cap internal spaces 141a and 141b until the negative pressure detection timing is preferably small. In addition, in terms of reducing a period of time required for cleaning by reducing a period of time from the initiation of the suction action to the negative pressure detection timing as well, the negative pressure detection timing is preferably at time t1.

In addition, in the first embodiment, prior to the suction action of step A13, the sliding action is performed in step A12. Thus, even when the seal contact portions SA are not favorably adhered to the nozzle forming face 91 and poor adherence is occurring in a state where the seal contact portions SA are just brought into contact with the nozzle forming face 91 in step A11, it is possible to reduce the poor adherence prior to the suction action of the cap internal spaces 131a and 131b in such a manner that the seal contact portions SA are made to slide over the nozzle forming face 91 in step A12. Hence, it is preferable.

That is, in a state where the seal contact portions SA simply contact the nozzle forming face 91 in step A11, adherence of the cap member 13 is extremely poor and, therefore, for example, a large gap, through which foreign matter may be included from the outside of the cap member, may possibly be formed between the seal contact portions SA and the nozzle forming face 91 of the recording head 9. Then, as the suction action is initiated in this state, not only a sufficient negative pressure is generated in each of the cap internal spaces 131a and 131b but also foreign matter may possibly be included into the cap internal space 131a or 131b through the gap between the seal contact portions SA and the nozzle forming face 91. Then, when the foreign matter clogs midway from the cap internal space 131a or 131b to the suction pump 14, there is a possibility that it is difficult to generate a negative pressure in each of the cap internal space 131a or 131b. Then, in the first embodiment, by performing the sliding action in step A12 prior to the suction action in step A13, poor adherence of the seal contact portions SA is reduced in advance of initiation of the suction action.

Then, after step A12 has been performed, it is actually measured in step A14 whether a negative pressure that is equal to or higher than a predetermined value is generated in each of the cap internal spaces 131a and 131b and, when the above negative pressure is not generated, the sliding action is performed in step A15. Thus, a negative pressure in each of the cap internal spaces 131a and 131b is further reliably generated.

Furthermore, as shown in steps A2 to A4 of FIG. 18, in the first embodiment, in order to make the seal contact portions SA slide over the recording head 9, the cap member 13 is reciprocally moved. That is, the cap member 13, in the reciprocal movement, moves from a position (a sliding initiation position) at the time when the sliding is initiated in a predetermined direction and returns again to the sliding initiation position. Thus, the positional relationship between the recording head 9 and the seal contact portions SA remains unchanged before and after the seal contact portions SA slide. Thus, when the fluid ejecting apparatus, such as the printer 1, is designed, it is not necessary to consider a difference in the positional relationship between the recording head 9 and the seal contact portions SA before and after the seal contact portions SA slide, and the design is easy and simple. Hence, it is preferable.

Incidentally, in the first embodiment, only one cap member 13 is provided for the recording head 9. However, the number of the cap members 13 is not limited to one. As will be described in the next second embodiment, the number of the cap members 13 may be multiple.

### Second Embodiment

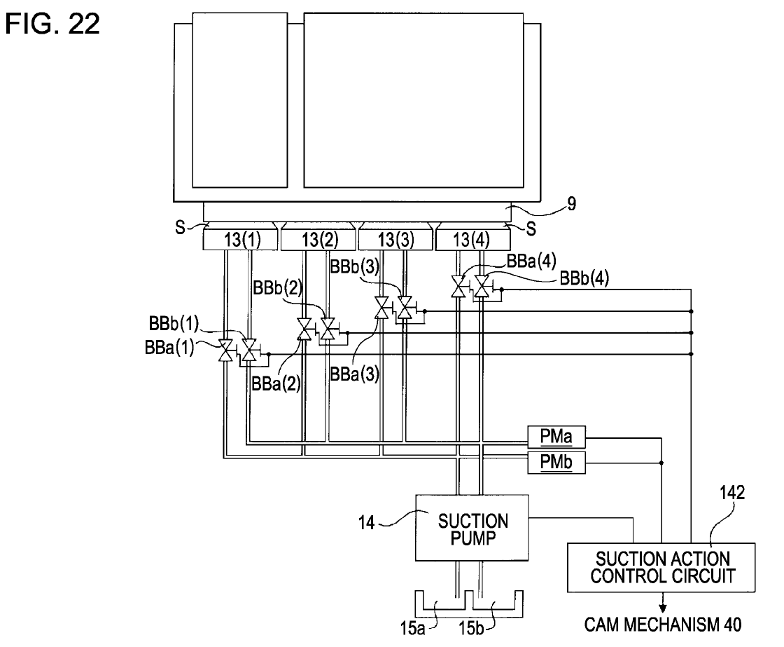

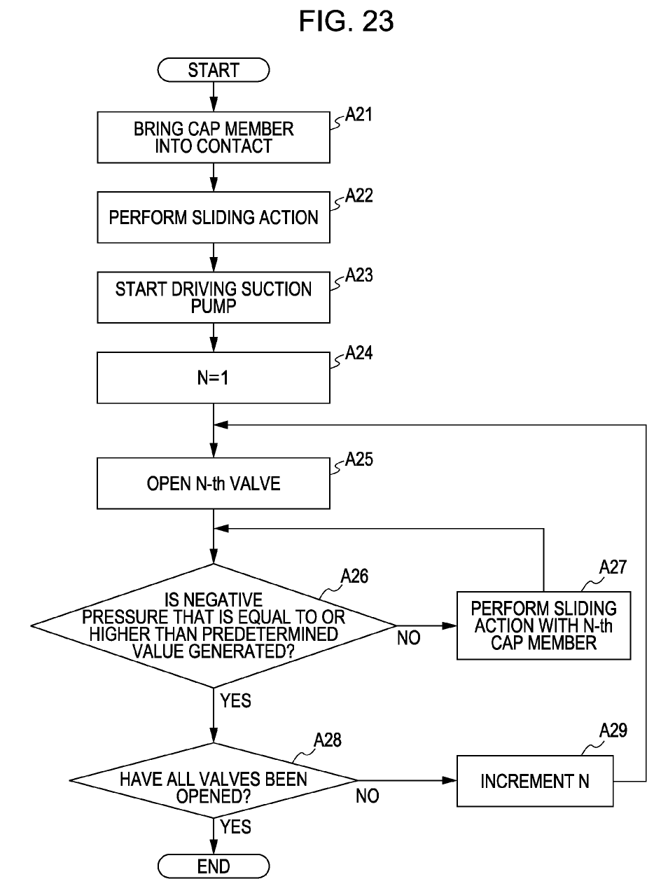

FIG. 22 is a view that shows the configuration that performs the suction action in the second embodiment. In addition, FIG. 23 is a flow chart of actions that are performed in the second embodiment. Note that, in the following description of the second embodiment, components that differ from those of the first embodiment will be mainly described, and the common components are assigned with the corresponding reference numerals and description thereof is omitted. In the second embodiment, four cap members 13(1) to 13(4) are provided for the nozzle forming face 91 of the recording head 9. Note that the configuration of each of the cap members 13(1) to 13(4) has the same configuration as the cap member 13 that is described with reference to FIG. 13.

Valves BBa(1) to BB(4) and BBb(1) to BB(4) are provided between the respective cap members 13(1) to 13(4) and the suction pump 14. That is, each of the valves BBa(1) to BBa(4) is provided between a corresponding one of the cap internal spaces 131a of the cap members 13(1) to 13(4) and the suction pump 14, and each of the valves BBb(1) to BBb(4) is provided between a corresponding one of the cap internal spaces 131b of the cap members 13(1) to 13(4) and the suction pump 14. Furthermore, the manometer PMa is provided between the valves BBa(1) to BBa(4) and the suction pump 14, and the manometer PMb is provided between the valves BBb(1) to BB(4) and the suction pump 14. That is, the manometer PMa monitors a pressure in the cap internal space 131a of the cap member 13(N) in a state where the valve BBa(N) is open, and the manometer PMb monitors a pressure in the cap internal space 131b of the cap member 13(N) in a state where the valve BBb(N) is open. Then, the suction action control circuit 142 controls the suction pump 14, the valves BBa(1) to (4), the valves BBb(1) to BBb(4) and the manometers PMa and PMb. In addition, as in the case of the first embodiment, the suction action control circuit 142 (control means) is able to control the cam mechanism 40 and drives the cam mechanism 40 on the basis of pressure values indicated by the manometers PMa and PMb to thereby make the maintenance unit 11 perform the sliding action, and the like.

Here, the cap member 13(1) to the cap member 13(4) that are aligned in order from the left hand side in FIG. 22 are respectively referred to as the first cap member 13(1) to the fourth cap member 13(4). In addition, the N-th cap member means the N-th cam member 13(N) from the left hand side in FIG. 22. In addition, the valves BBa(N) and BBb(N) corresponding to the N-th cap member 13(N) are referred to as the N-th valves BBa(N) and BBb(N).

The flow shown in FIG. 23 will be described. In step A21, all the cap members 13(1) to 13(4) are brought into contact with the nozzle forming face 91 of the recording head 9 through the respective seal contact portions SA (cap contact step). Then, in step A22, the sliding action is performed in each of the cap members 13(1) to 13(4), so that the seal contact portion SA of each of the cap members 13(1) to 13(4) is made to slide over the recording head 9. This sliding action is the same as the actions from step A2 to step A4 shown in FIG. 18. Then, driving of the suction pump 14 is initiated (step A23), and 1 is substituted for the value N (step A24). Then, the N-th valves BBa(N) and BBb(N) are opened (step A25). Thus, the cap internal spaces 131a and 131b of the N-th cap member 13(N) are sucked by the suction pump 14 (cap suction step).

In addition, in the second embodiment, pressures in the cap internal spaces 131a and 131b of the N-th cap member 13(N) are monitored by the manometers PMa and PMb. Then, at the time when a predetermined time t1 has elapsed from the time at which the suction pump 14 initiates suction, the suction action control circuit 142 determines whether the negative pressure Pth that is equal to or higher than a predetermined value is generated in each of the cap internal spaces 131a and 131b of the N-th cap member 13(N) (step A26, pressure determination step). That is, it is determined whether a pressure that is lower than a pressure that is obtained by subtracting the negative pressure Pth from the atmospheric pressure is generated in each of the cap internal spaces 131a and 131b. Then, when it is determined that a negative pressure that is equal to or higher than a predetermined value is not generated in any one of the cap internal spaces 131a and 131b (when it is determined “NO” in step A26), the process proceeds to step A27, and the sliding action is performed on the N-th cap member 13(N) (cap sliding step). By performing the steps A26 and A27 in this way, it is possible to suppress poor adherence of the N-th cap member 13(N).

In addition, when it is determined “YES” in step A26, the process proceeds to step A28, and it is determined whether all the valves BBa and BBb have been opened. When not all the valves BBa and BBb have been opened, the value N is incremented (step A29) and then the process proceeds to step A25. That is, until all the valves BBa and BBb have been opened, the actions from step A25 to A28 are repeated. In this manner, it is possible to suppress poor adherence in all the cap members 13(1) to 13(4).

In this way, in the second embodiment, pressures in the cap internal spaces 131a and 131b are respectively monitored (measured) by the manometers PMa and PMb while the suction action is being performed by the suction pump 14 (step A26). That is, the second embodiment is configured to be able to detect whether a sufficient negative pressure is generated in each of the cap internal spaces 131a and 131b by providing the manometers PMa and PMb. Then, when a negative pressure that is equal to or higher than a predetermined value is not generated, it is determined that poor adherence of the seal contact portions SA is occurring, and the sliding action is then performed (step A27). Thus, even when the seal contact portions SA are not favorably adhered to the recording head 9 and poor adherence is occurring, by performing steps A26 and A27, it is possible to suppress poor adherence between the seal contact portions SA of each of the cap members 13(1) to 13(4) and the nozzle forming face 91 of the recording head 9. Hence, it is preferable. Thus, a sufficient negative pressure may be generated in each of the cap internal spaces 131a and 131b, and, in addition, clogging, or the like, may be effectively removed.

In addition, in the second embodiment as well, as in the case of the first embodiment, prior to the suction action (step A23), the sliding action is performed (step A22). Thus, it is possible to reduce the poor adherence of the seal contact portions SA prior to the suction action of the cap internal spaces 131a and 131b. Hence, it is preferable.

Others

Note that the invention is not limited to the embodiments described above, but it may be modified into various forms other than the one described above without departing from the spirit of the invention. For example, in the above embodiments, the sliding action of the seal contact portions SA over the nozzle forming face 91 is performed by reciprocally moving the cap member 13 in a direction parallel to the nozzle forming face 91. However, the manner in which the sliding action is performed is not limited to it. For example, the sliding action may be performed in such a manner that the cap member 13 is rotated about a rotation axis that is perpendicular to the nozzle forming face 91 in a state where the seal contact portions SA of the cap member 13 are in contact with the nozzle forming face 91. That is, it is possible to suppress occurrence of poor adherence in the seal contact portions SA in such a manner that the seal contact portions SA of the cap member 13 is made to slide over the nozzle forming face 91.

In addition, in the above embodiments, the sliding action of the seal contact portions SA over the nozzle forming face 91 is performed by reciprocally moving the cap member 13 in a direction parallel to the nozzle forming face 91. At this time, the reciprocal movement may be performed multiple times. This is because, by performing the reciprocal movement of the cap member 13 multiple times, adherence of the seal contact portions SA to the recording head 9 may further effectively be favorable.

Furthermore, the application target of the invention is not limited to the above printer 1, but the invention may also be applied to a display manufacturing equipment, an electrode manufacturing equipment, a chip manufacturing equipment, and a fluid ejecting apparatus, such as a micropipette. That is, the invention may be applied to all apparatuses that perform cleaning of the nozzles in such a manner that the cap member 13 is brought into close contact with the recording head 9 and a negative pressure is generated in each of the cap internal spaces 131a and 131b.

What is claimed is:

1. A fluid ejecting apparatus comprising:
a fluid ejecting head that ejects fluid from a nozzle opening of a nozzle;
a cap that has a cap opening open toward the fluid ejecting head and an annular cap contact portion provided at a periphery of the cap opening, wherein the cap is provided so as to be operable to move away from the fluid ejecting head or contact the fluid ejecting head through the cap contact portion, and wherein the cap opening encloses the nozzle opening in such a manner that the cap contact portion contacts the fluid ejecting head;
a cap separate and contact means that moves the cap to thereby move the cap away from the fluid ejecting head or bring the cap into contact with the fluid ejecting head;
a cap suction means that sucks a cap internal space formed between the fluid ejecting head and an inner wall of the cap in a state where the cap is in contact with the fluid ejecting head;
a control means that measures a pressure in the cap internal space sucked by the cap suction means and that determines whether a negative pressure that is equal to or higher than a predetermined value is generated in the cap internal space; and
a cap sliding means that performs a sliding action in which the cap contact portion is made to slide over the fluid ejecting head in a state where the cap is in contact with the fluid ejecting head, wherein
the control means instructs the cap sliding means to perform the sliding action when the control means determines that the negative pressure that is equal to or higher than the predetermined value is not generated in the cap internal space.

2. The fluid ejecting apparatus according to claim 1, wherein the control means determines whether the negative pressure that is equal to or higher than the predetermined value is generated while the suction action is being performed by the cap suction means.

3. The fluid ejecting apparatus according to claim 1 in which the fluid ejecting head has a nozzle opening plane and the nozzle opening is open at the nozzle opening plane, wherein
the cap contact portion contacts the nozzle opening plane in a state where the cap is in contact with the fluid ejecting head, and wherein
the cap sliding means reciprocally moves the cap in a direction parallel to the nozzle opening plane to thereby make the cap contact portion slide over the fluid ejecting head.

4. The fluid ejecting apparatus according to claim 3, wherein the cap sliding means performs the reciprocal movement of the cap multiple times.

5. A method of controlling a fluid ejecting apparatus that includes a fluid ejecting head that ejects fluid from a nozzle opening of a nozzle, and a cap that has a cap opening open toward the fluid ejecting head and an annular cap contact portion provided at a periphery of the cap opening, comprising:
a contact step of bringing the cap contact portion of the cap into contact with the fluid ejecting head to thereby enclose the nozzle opening with the cap opening;
a cap suction step of sucking a cap internal space formed between the fluid ejecting head and an inner wall of the cap in a state where the cap is in contact with the fluid ejecting head;
a pressure determination step of measuring a pressure in the cap internal space sucked in the cap suction step and determining whether a negative pressure that is equal to or higher than a predetermined value is generated in the cap internal space; and
a cap sliding step of, when it is determined that the negative pressure that is equal to or higher than the predetermined value is not generated in the pressure determination step, sliding the cap contact portion over the fluid ejecting head in a state where the cap is in contact with the fluid ejecting head.
